(19) United States
(12) Patent Application Publication
(10) Pub. No.: US 2012/0207416 A1
(43) Pub. Date: Aug. 16, 2012

(54) BEARING ASSEMBLY

(76) Inventors: Berthold Beyfuss, Kaisten (DE); Alexander Dilje, Schweinfurt (DE); Helmut Hauck, Euerbach (DE); Alfred Radina, Poppenlauer (DE); Peter Scharnberger, Untereisenheim (DE); Stefanie Seufert, Rothhausen (DE); Jürgen Theuerer, Kolitzheim (DE)

(21) Appl. No.: 13/391,909

(22) PCT Filed: Aug. 12, 2010
(86) PCT No.: PCT/EP2010/061715

§ 371 Date: May 1, 2012

(30) Foreign Application Priority Data
Aug. 24, 2009 (EP) 09010801.0

(51) Int. Cl. F16C 35/04

(52) U.S. Cl. 384/445

(57) ABSTRACT

A bearing assembly comprises a bearing support having at least one receptacle for a bearing. The bearing support also has at least one attachment segment for abutment and attachment of the bearing support onto an attachment portion of another component, such as a housing. At least one centering element protrudes in the axial direction and is disposed on the side of the attachment segment of the bearing support that faces towards the attachment portion of the other component. The at least one centering element is configured to at least partially enter into a corresponding opening in the attachment portion of the other component.

The invention relates to a bearing assembly comprising a bearing support, wherein the bearing support comprises at least one receptacle for a bearing, in particular for a rolling-element bearing, and wherein the bearing support comprises at least one attachment segment, which is provided for abutment and attachment of the bearing support onto an attachment area of another component, in particular a housing.

Bearing assemblies of this type are well known in the prior art. Reference is made in an exemplary manner to DE 100 07 437 A1. Here a bearing support is formed from a plate, which includes a pot-shaped receptacle for the outer ring of a rolling-element bearing. A gear shaft is supported by the bearing, particularly in the application of an automobile transmission. The bearing support itself is fastened to a housing using screws. The bearing support can thus function as a part of the wall of the housing. Since the dimensional and shape accuracy of the shaft seat must be high, and thus the position of the bearing seat must be precise, the bearing support is manufactured in a correspondingly precise manner. When it comes to the centering of two parts prior to screwing them together, various measures have become known in the prior art, which are generally utilized in machine construction, to ensure the precise mounting of the bearing support on the housing. Thus it is possible, for example, to define with locating pins the precise position of the bearing support on the housing. Precisely manufactured collar surfaces on the bearing support that cooperate with corresponding surfaces on the housing are also possible, thus fixing the bearing support on the exact desired location on the housing.

Disadvantageous in this context are the often significant manufacturing and installation costs when manufacturing and assembling a housing using a bearing assembly of the above-mentioned type.

The object underlying the invention is therefore to further develop a bearing assembly of the type mentioned in the introduction above, such that it is possible to precisely fix the bearing support on the supporting component in a simpler and more cost-effective matter with regard to manufacturing as well as also installation. Therefore, the manufacture of bearing assemblies of the above-mentioned type in an efficient manner should also be possible in mass production.

The solution to this problem by the invention is characterized in that, on the side of the attachment segment of the bearing support that faces towards the attachment portion of the other component, at least one centering element protruding in the axial direction is disposed that can at least partially enter into a corresponding opening in the attachment portion of the other component.

An anchoring segment of the at least one centering element can be disposed in a bore in the bearing support extending in the axial direction.

The at least one centering element can have a centering segment extending in the axial direction. The centering segment is preferably formed cylindrically at least in section(s). The outer diameter of the cylindrical part of the centering segment is preferably larger than the diameter of the bore. To simplify the insertion of the centering segment into the opening in the other component, the centering segment can be provided with a chamfer, in particular with a conical taper, in its end portion that faces towards the attachment portion of the other component. The anchoring segment of the centering element can further have a diameter increase at its end that faces away from the centering segment; the bore in the bearing support can then have a corresponding diameter increase in the area of the diameter increase of the anchoring segment.

The centering element can be pushed into the bore in the bearing support and held in the bore by friction-fit or interference-fit.

The centering element is preferably made of plastic.

In this case, it may be provided that the centering element is injection molded onto the bearing support and into the bore, respectively, by an injection molding process.

Preferably, a plurality of centering elements are disposed around the circumference of the bearing support; two, three, or four centering elements around the circumference of the bearing support are thought to be especially preferred.

The bearing support is preferably made of a metal plate part having a substantially constant thickness.

Finally, the bearing support can have through bores for the passage of attachment means, in particular for the passage of screws.

The invention is particularly preferably used in an automobile transmission.

In an advantageous way, the proposed design may be implemented in such a way that only small modifications are required to an existing production of bearing supports, especially as concerns the metal plate processing.

Manufacturing tolerances can be compensated for in a simple manner with the proposed conception.

An exemplary embodiment of the invention is shown in the drawings.

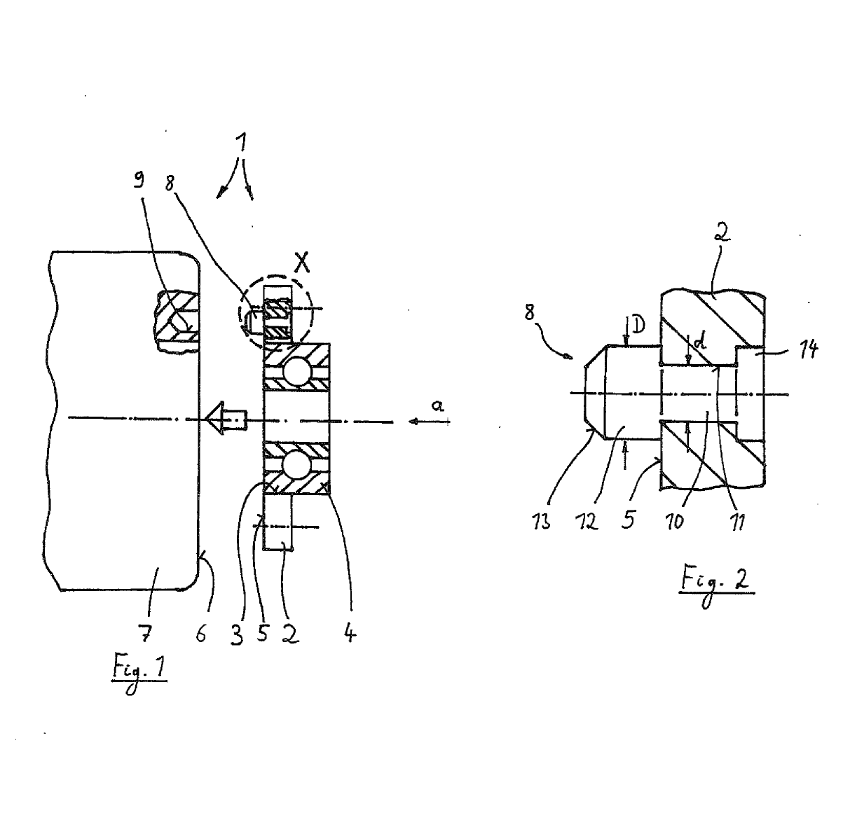

FIG. 1 shows a side view illustrated in partial cutaway of a bearing support with a rolling-element bearing, which is to be attached to a housing of a transmission; illustrated is the position before the bearing support is abutted onto the housing together with the bearing,

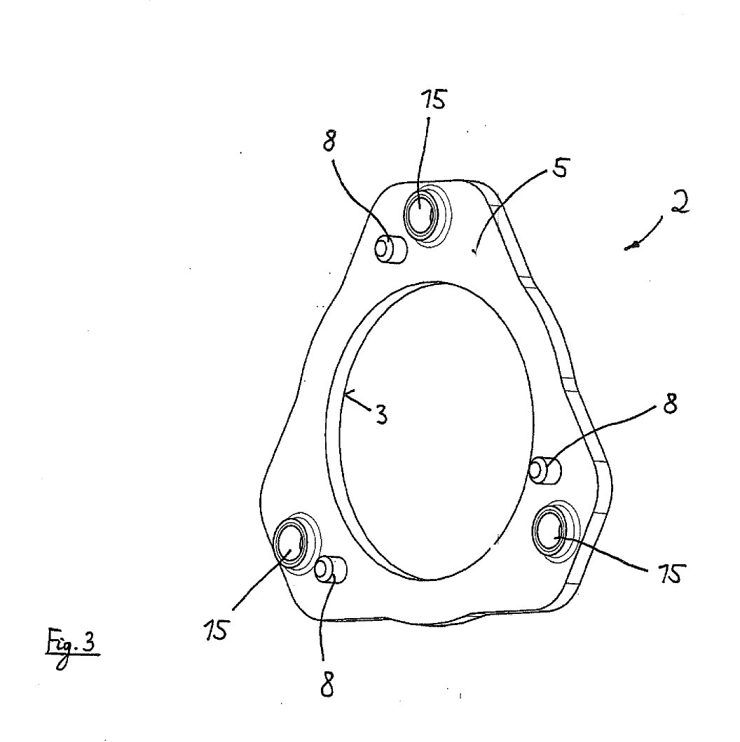

FIG. 2 show the detail “X” according to FIG. 1 and

FIG. 3 shows in perspective illustration the bearing support of the bearing assembly.

In the Figures, a bearing assembly 1 can be seen that comprises a bearing support 2, which has a circular receptacle 3 for the outer ring of a rolling-element bearing 4. The attachment of the bearing outer ring on the bearing support 2 can be effected for example with press-fit stems or in another way. Such attachment options are adequately described in the prior art, so that reference may be made to these; mentioned as an example is DE 100 07 437 A1 mentioned in the introduction above.

The bearing support 2 has an attachment segment 5, which is formed flat and is configured to be abutted and attached to an attachment portion 6 of another component 7 in the form of a transmission housing.

In order that the attachment may be effected in a simple and precisely centered manner, the bearing support 2 has a plurality of centering elements 8, three in the exemplary embodiment, the construction and arrangement of which in the bearing support 2 is best seen from FIG. 2.

A number of openings 9, which correspond to the number of the centering elements 8, in the form of bores are introduced into the attachment portion 6 of the transmission housing 7. If—as indicated by the arrow in FIG. 1—the bearing support 2 assembled together with bearing 4 is pushed in the axial direction a against the transmission housing 7, the centering elements 8 and namely their centering segments 12 arrive in the openings 9, so that, before the attachment of the bearing support 2 to the transmission housing 7 takes place, the bearing support 2 together with the bearing 4 is precisely centered on transmission housing 7.

Subsequently the bearing support 2 is attached to the transmission housing 7 in a known manner using attachment screws; through bores 15 for the screws are therefore present in bearing support 2.

Details of the design of the centering elements 8 and their arrangement in the bearing support 2 are apparent from FIG. 2. Bores 11 are introduced into the bearing support 2. The portion of the centering element 8 that faces away from centering segment 12 has an anchoring segment 10. Thus, in the state in which the centering element 8 is disposed in bearing support 2, a press-fit is preferably present between the cylindrical anchoring segment 10 and the cylindrical bore 11.

The diameter d of the anchoring segment 10 and/or the bore 11 is thus smaller than the outer diameter D of the centering segment 12. The centering segment 12 thereby has a defined abutment on the attachment segment 5 of the bearing support 2.

In the exemplary embodiment, it is provided that the anchoring segment 10 has a diameter increase 14 in its end that faces away from centering segment 12. The centering element 8 can be hereby held in the bearing support 2 by an interference-fit, as the bore 11 in bearing support 2 is also increased in diameter in the area of the diameter increase 14 of the anchoring segment 10.

To simplify the insertion of the centering segments 12 into the openings 9 in the transmission housing 7, they have a chamfer 13 on the end side.

In the simplest case, the centering elements 8 are manufactured as separate shaped parts, preferably from plastic. They are then axially pushed or pressed into the bores 11 in the bearing support 2 and thereby fixed in the bearing support.

Another possibility is to mount the plastic centering elements 8 on the bearing support by compression molding on the bearing support 2 or by injection molding in the bores 11 of the bearing support.

### REFERENCE NUMBER LIST

1 bearing assembly
2 bearing support
3 receptacle
4 bearing
5 attachment segment
6 attachment portion
7 other component (transmission housing)
8 centering element
9 opening
10 anchoring segment
11 bore
12 centering segment
13 chamfer (conical taper)
14 diameter increase
15 through bore
a axial direction
D outer diameter
d diameter

1.-15. (canceled)

16. A bearing assembly comprising a bearing support including:
at least one receptacle configured to receive a bearing,
at least one bore defined in the bearing support and extending in an axial direction,
at least one attachment segment configured to abut on and attach to an attachment portion of a separate component,
at least one centering element having a centering segment projecting in the axial direction and disposed on a side of the attachment segment that faces towards the attachment portion of the separate component,
wherein the at least one centering element is configured to at least partially enter into a corresponding opening defined in the attachment portion of the separate component,
an anchoring segment of the at least one centering element is disposed in the at least one bore, extends in the axial direction and has an increased diameter portion on its end that is opposite of the centering segment,
the increased diameter portion of the anchoring segment is disposed in a correspondingly increased diameter portion of the at least one bore, and
an end side of the increased diameter portion of the anchoring segment spaced from the centering segement terminates in a flush manner with an end side of the attachment segment.

17. The bearing assembly according to claim 16, wherein at least one section of the centering segment is cylindrical.

18. The bearing assembly according to claim 17, wherein a cylindrical part of the centering segment has an outer diameter that is greater than the diameter of the bore.

19. The bearing assembly according to claim 18, wherein the centering segment has a chamfer on its end portion that faces towards the attachment portion of the separate component.

20. The bearing assembly according to claim 19, wherein the chamfer has a conical taper shape.

21. The bearing assembly according to claim 20, wherein the centering element is held within the bore by one of a friction-fit and an interference-fit.

22. The bearing assembly according to claim 21, wherein the centering element is made of plastic.

23. The bearing assembly according to claim 22, wherein the centering element is injection molded at least one of: onto the bearing support and into the bore.

24. The bearing assembly according to claim 23, wherein a plurality of centering elements are disposed around the periphery of the bearing support.

25. The bearing assembly according to claim 24, wherein two, three, or four centering elements are disposed around the periphery of the bearing support.

26. The bearing assembly according to claim 25, wherein the bearing support is made from a metal plate part having a substantially constant thickness.

27. The bearing assembly according to claim 26, further including at least one through bore configured to receive an attachment means therethrough.

28. The bearing assembly according to claim 16, wherein the centering segment has a chamfer on its end portion that faces towards the attachment portion of the separate component.

29. The bearing assembly according to claim 28, wherein the chamfer has a conical taper shape.

30. The bearing assembly according to claim 16, wherein the centering element is held within the bore by one of a friction-fit and an interference-fit.

31. The bearing assembly according to claim 16, wherein the centering element is made of plastic.

32. The bearing assembly according to claim 16, wherein a plurality of centering elements are disposed around the periphery of the bearing support.

33. The bearing assembly according to claim 16, wherein two, three, or four centering elements are disposed around the periphery of the bearing support.

34. The bearing assembly according to claim 16, wherein the bearing support is made from a metal plate part having a substantially constant thickness.

35. The bearing assembly according to claim 16, further including at least one through bore configured to receive an attachment means therethrough.
